(19) United States
(12) Patent Application Publication
(10) Pub. No.: US 2002/0078576 A1
(43) Pub. Date: Jun. 27, 2002

(54) Micromachined surgical scalpel

(76) Inventors: William N. Carr, Montclair, NJ (US); Changging Zhan, Kearny, NJ (US)

Correspondence Address: ALEXANDER USENKO, 20 SOUTHGATE ROAD #2, MURRAY HILL, NJ, 07974-1607, US

(21) Appl. No.: 09/746,982

(22) Filed: Dec. 23, 2000

Related U.S. Application Data
(60) Provisional application No. 60/247,164, filed on Nov. 10, 2000.

(51) Int. Cl. B26B 9/02

(52) U.S. Cl. 30/357

(57) ABSTRACT

A multilevel structures is formed with the cubic crystal material typically silicon. Structures with {111} sidewalls are formed for a desired etching depth on the surface of a (100) silicon wafer by a conventional masked anisotropic etching process using a specially designed etching mask. Then, the etching mask is removed except for some areas (including the frame area) and a maskless etching follows. In the downward etching of the upper and lower (100) planes during maskless etching, the {111] sidewalls will finally be replaced by {311} planes. The cutting edge apex angle is 25.24 degrees and is that angle determined by the intersection of the {100} and {311] planes.

The multilevel structures can be used as scalpels in surgery.

### FIELD OF THE INVENTION

This invention describes a surgical scalpel and means of fabrication using micromachining technology.

### DESCRIPTION OF RELATED ART

Several attempts have been made to improve the sharpness of surgical cutting tools and also to produce these tools at a lower cost to enhance disposability. In previous art, the tools have been mostly made of steel or other metals. Since metals are polycrystals the radii of curvature of cutting edges are limited by grain sizes of polycrystals. With metal cutting edges it is difficult to make produce cutting edges with radii of curvature less than several tens of nanometers. Also the sharper edges are obtained using more costly manufacturing processes. The more expensive surgical cutting tools cannot be considered disposable due to the high cost of production. Efforts have been made to develop single crystal cutting tools with technologies that potentially improve sharpness and disposability. Several methods to manufacture silicon micromachined tools are decribed in previous art and are reviewed below.

Mehregany describes a micromachined cauterizing knife with etch planes of {100}, {110}, and {110} to define a cutting edge. The present patent represents an improvement overMehregany by obtaining a cutting edge with a smaller apex angle based on a lithography-based procedure for bulk micromachining.

Marcus describes a cutting tool formed using micromachining techniques in which sharpening by oxidation is used. This patent does not utilize specific crystallographic planes to define a straight line cutting edge. The cutting edge in the Marcus patent is curved.

Lee describes a silicon device with microelectrodes for cauterizing and cutting. One of the embodiments is a bimorph is for pinching and cutting. This is a micromachined structure without reference to the use of single crystal crystallographic planes to define a cutting edge.

Bartholomew describes a method of creating a surgical cutting edge that is not defined by crystallographic planes but instead forms a cutting ridge above a planer substrate surface.

Henderson describes a cutting tool formed using crystal aluminum oxide with anisotropic etching to define a sharp edge in this material.

Bao describes a micromachining technology for silicon multilevel structures in which first structures with {111} plane sidewalls are preferentially formed using anisotropic etching. During the process fast etching rate {311} planes emerge at the edge of {111} planes to define surface structures. Bao discusses the use of anisotropic etching to define {311} planes on silicon surfaces. Bao does not create sharp edges that would be used to define a scalpel or knife.

Anisotropic etching of silicon has been widely used in the fabrication of silicon sensors, actuators and other devices for many years. The traditional anisotropic etch is a masked etch used with liquid etchants. The present invention utilizes top-surface patterning to control bulk anisotropic micromachining to form cutting tools.

It is the purpose of the present invention to create cutting edges of typically millimeter- and centimeter-length using anisotropic etching of a cubic crystal such as silicon. The sharp cutting edge of the scalpel is created typically using less than 4 masks.

### BRIEF SUMMARY OF THE INVENTION

A multilevel structure is formed from a cubic crystal material typically silicon. A surgical cutting edge is defined by the intersection of the {311} and {100} or equivalent crystal planes. Other defined planes including the {111} planes are process-defined to create a surgical scalpel.

Structures with {111} sidewalls are formed for a desired etching depth on the surface of a (100) silicon wafer by a conventional masked anisotropic etching process using a specially designed etching mask. Next, the etching mask is removed except for certain areas (including the frame area) and a maskless etching follows. In the downward etching of the upper and lower (100) planes during maskless etching, the {111] sidewalls will eveentually be replaced by {311} planes as the etching process continues. The cutting edge apex angle is 25.24 degrees and is that angle determined by the intersection of the {100} and {311] planes. These multilevel structures are used as microknives for surgical cutting.

### BRIEF DESCRIPTION OF THE SEVERAL VIEWS OF THE DRAWINGS

FIG. 1 Photomask 1 and Photomask 2.

FIG. 2. Cross-section of scalpel in process with two masking films, and selective patterning with photomask 1.

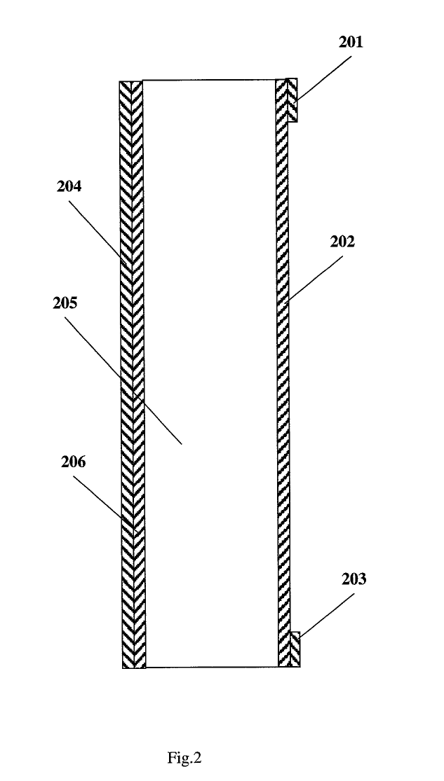

FIG. 3 Cross-section of scalpel in process with first selective patterning using photomask 2 and after anisotropic etch #1.

FIG. 4. Cross-section of scalpel in process with second selective patterning with photomask 2.

FIG. 5 Cross-section of scalpel in process with anisotropic etch step # 2 to define the sharp cutting edge.

FIG. 6 Cross-section view of embodiment 3 a double-edge scalpel showing the cutting edges and with sharpening masks applied to both frontside and backside of the crystal wafer, Cross-section view of embodiment 2 a double-edged scalpel showing the cutting edges and after an anisotropic backside thinning etch #3, Isometric view of embodiment 1 with handle structure attached to the cutting geometry.

FIG. 7 Isometric view of embodiment 1 a double-edge scalpel after edge definition and before release from the host wafer.

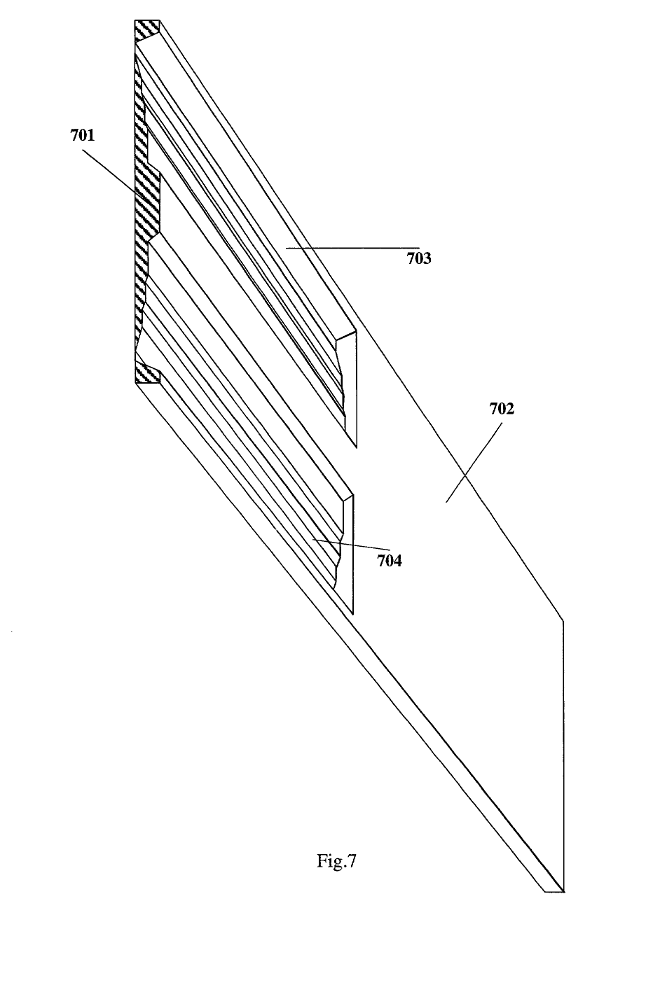

FIG. 8 Isometric view of embodiment 1 with exposed cutting edges and with micromachined structure mounted in a holder.

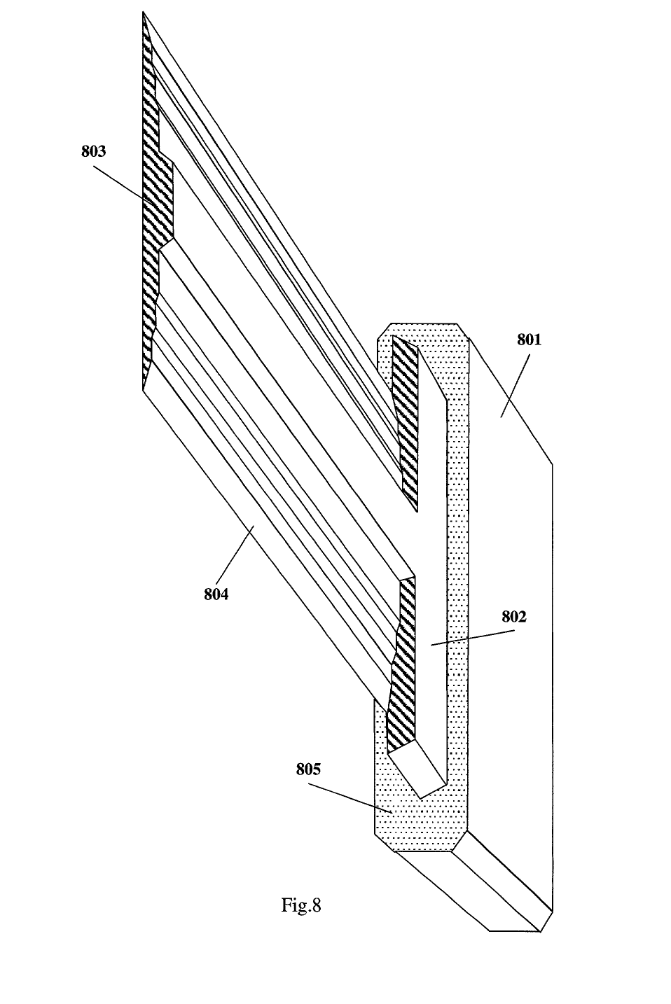

FIG. 9 Cross-section view showing an embodiment with serrated cutting line.

### DETAILED DESCRIPTION OF THE INVENTION

A novel micromachining technology for multilevel structures is used with a cubic crystal material typically of silicon. Structures with {111} sidewalls are formed for a desired etching depth on the surface of a (100) silicon wafer by a conventional masked anisotropic etching process using a specially designed etching mask. Then, the etching mask is removed except for some areas (including the frame area) and a maskless etching follows. In the downward etching of the upper and lower (100) planes during maskless etching, the {111] sidewalls will finally be replaced by {311} planes. The cutting edge apex angle is 25.24 degrees and is that angle determined by the intersection of the {100} and {311] planes.

Initially the silicon wafer is oxidized in a steam ambient at 1100 deg C. to obtain a surface film of SiO₂ and a thickness of 0.8 micrometer. This is followed by a low pressure chemical vapor deposition (LPCVD) of silicon nitride to a thickness of 100 nanometers using silane and ammonia precursors. The starting silicon wafer is double-side polished, oriented (100). The wafers used are of standard diameters. For the embodiments described below the starting wafer is 100 millimeter diameter and of thickness of 500 +/−25 micrometer.

The typical etchant used for dissolving the silicon surface is potassium hydroxide KOH. Alternate etchants than can be used under specific temperature-controlled conditions include KOH with ethanol, hyrdazine, ethylene pyrocatechol, xenon difluoride, and tetramethyl ammonium hydroxide.

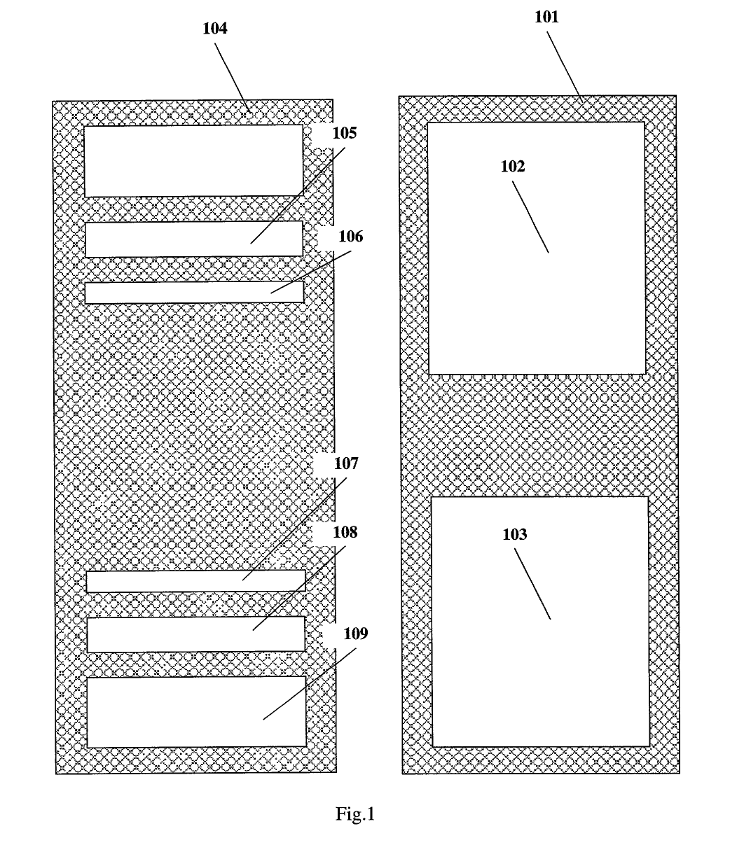

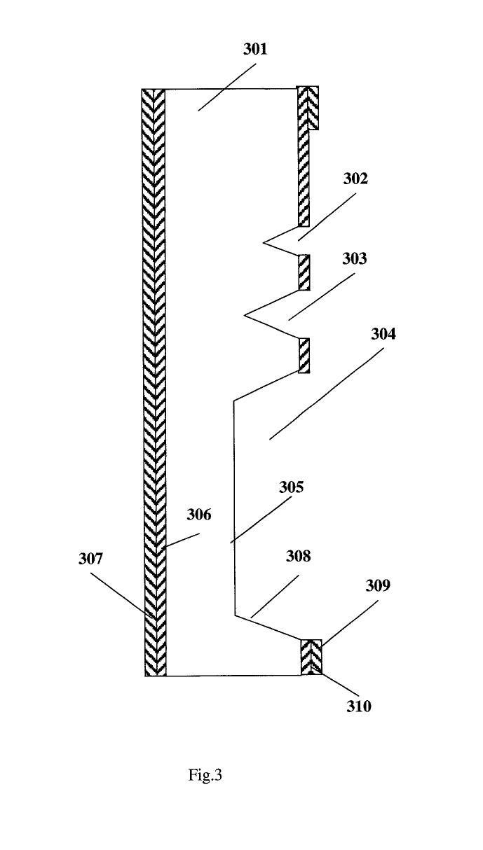

The surface is patterned using photomask 104 of FIG. 1 to selectively remove the top level silicon nitride using the silicon dioxide as an etch stop. The silicon nitride is patterned using a reactive ion etch RIE step typically using precursors of the C-F family or with SF₆. Next the remaining SiO₂ film is patterned using photomask 101 with an RIE etch stopping at the surface of the silicon substrate. Next the exposed silicon surface is dissolved using a hot solution of potassium hydroxide KOH. A typical KOH etch is performed at 50 deg C. using an aqueous solution of KOH 50% by weight with water. The KOH etches the {111} sidewalls slowly and the {100} horizontal surface faster and thereby creates the cross section of FIG. 3.

The depth of the {1 00} cavity is 110 micrometers in this embodiment. The separation of the ribs is 110 and 219 micrometers. The initial width of the cavity on photomask 101 is 845 micrometers.

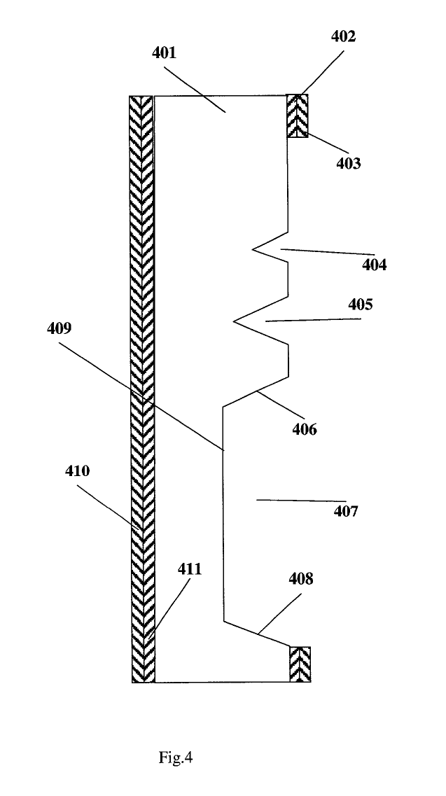

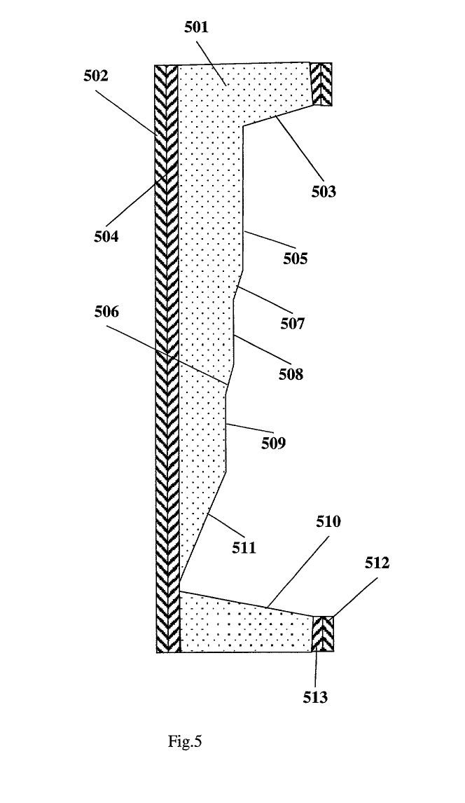

The cross section of FIG. 4 is next achieved by selectively etching the silicon nitride 403 from the silicon surface to expose additional silicon surface for further etching. The next KOH etching procedure is performed on the structure seen in FIG. 5 to obtain the deeper etched structure of FIG. 5. The {311} plane appears as a fast etching plane at the edge of the {111} sidewalls. As the {311} planes replaces the {111} sidewalls with a rate faster than the extension rate of the {111} planes, the {111} sidewall is replaced by the {311} planes. Levels with different depths 505, 508, 509, can be created in this way for different window apertures and the depths of the new levels can be individually determined by the design of the mask for masked etching. The end point of etching in FIG. 5 is determined by stopping the etch at or near the time at which the sharp knife edge is formed.

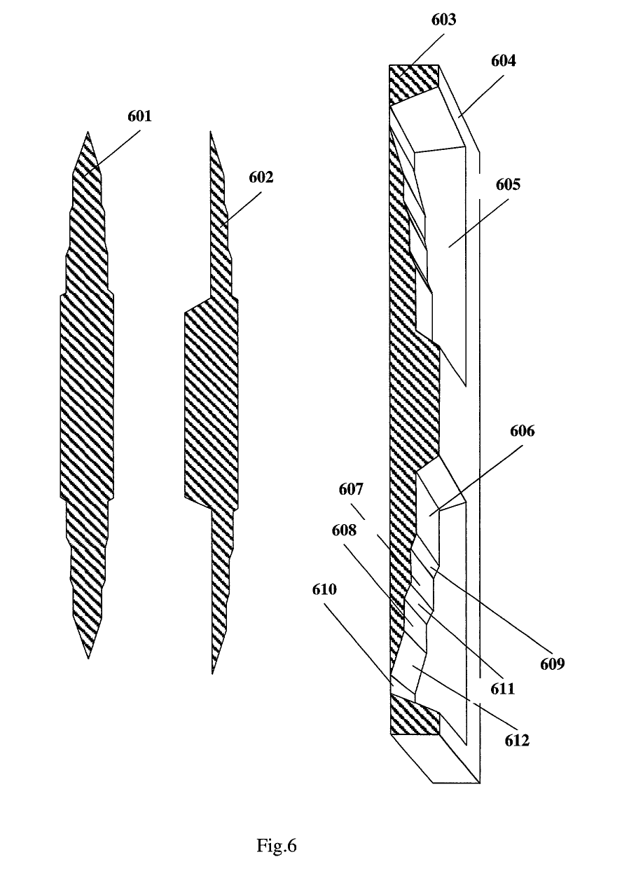

A larger view of the structure of FIG. 5 is shown in the isometric view of FIG. 6. This figure shows the full wafer thickness around the 3 peripheral boundaries of the micromachined structure. The fourth peripheral plane is parallel to the {100} plane is obtained by sawing the wafer into die (individual scalpels).

A variation in the embodiment 1 masking process can be used to obtain embodiment 2 of FIG. 6. In embodiment 2 a single side of the silicon wafer 602 is micromachined to create the top surface identical to embodiment 1. The backside is masked in a very conventional way to define the deep etch into the {100) planes to produce a knife with a thinner blade in the cutting area. The backside mask is a single photomask #3 which is not patterned until the backside is to be etched. The backside etch can be done simultaneous with the deep frontside etch or it can be done separately.

A third embodiment 3 can be obtained by applying the same masking with photomasks #1 and #2 to both the front and back sides of the wafer and with these two masks aligned with respect to one another. The result is the structure of 601 on FIG. 6 with a 50.48 degree apex angle for the cutting edge. This apex angle of FIG. 6 is formed by the intersection of the {311} and {311} planes.

Other cubic structure crystals that have etch planes similar to silicon include gallium arsenide can also be etched anisotropically using well known etchants.

The intersection of the {311} and {111} planes can be used to define multiple cutting edges. For instance, a 3-edged cutting tool can be obtained by defining the three orthogonal intersection edges using anisotropic etching with the fourth side constituting a structural handle.

Additional patterned structures may be created into the surfaces of the cutting tool. The structures for heating, monitoring surface breakage, and temperature sensing as described by Carr and Ladocsi in U.S. Pat. No. 5,980,518 can be made part of the present cutting tool. These structures are typically created on an original (unetched) {100} crystal surface.

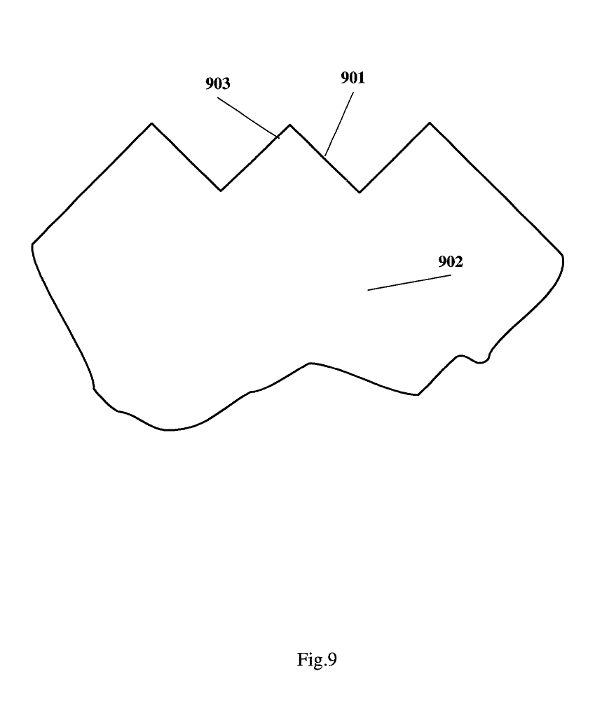

This technology can be used to create a fourth embodiment which contains a serrated cutting edge by orienting masks at a 90 degree angle within the plane of the starting {111}. A top view of the serrated cutting edge is shown in FIG. 9 as obtained by precisely defining an etch mask which is oriented 90 degrees off the alignment illustrated in FIG. 1.

It is to be understood that the above-described embodiments are merely illustrative of the invention and that many variations may be devised by those skilled in the art without departing from the scope of the invention and from the principles disclosed herein. It is therefore intended that such variations be included within the scope of the following claims and their equivalents.

1. A micromachined cutting blade, comprising
a body of single cubic crystal having at least one linear cutting edge defined by the intersection of two crystal planes having an apex angle of intersection and with crystal plane surfaces obtained by micromachining using the dissolved silicon etch process of anisotropic etching and with the crystal plane surfaces obtained using surface photomask films selectively removed at steps during said dissolved silicon processing.

2. The blade of claim 1 with the cutting edge formed by the intersection of {311} and {100} planes to form an apex angle of 25 degrees.

3. The blade of claim 1 with the cutting edge formed by the intersection of {311} and {311} planes to form an apex angle of 50 degrees.

4. The blade of claim 1 with a plurality of cutting edges formed as a continuous cutting line.

5. The blade of claim 4 with multiple cutting edges forming a serrated cutting line.

6. The blade of claim 1 formed of silicon single cryctal.

7. The blade of claim 1 with structures formed into or on the blade for the purpose of heating, temperature sensing, and/or detecting broken cutting edges.
